(19) United States
(12) Patent Application Publication
(10) Pub. No.: US 2026/0182777 A1
(43) Pub. Date: Jul. 2, 2026

(54) GRILLING BASKET WITH REAR RELEASE HANDLE

(71) Applicant: Frederick B. Swensen, Santa Fe, TX (US)

(72) Inventor: Frederick B. Swensen, Santa Fe, TX (US)

(21) Appl. No.: 19/396,284

(22) Filed: Nov. 20, 2025

Related U.S. Application Data
(60) Provisional application No. 63/739,462, filed on Dec. 27, 2024.

(51) Int. Cl. A47J 37/07; A47J 45/07

(52) U.S. Cl. CPC A47J 37/0786; A47J 45/07

(57) ABSTRACT

A grilling apparatus comprising a grilling basket and a handle. The handle is configured for a quick and remote release and connection with the grilling basket. The handle includes a release mechanism that is configured to be actuated at a rear end of the handle. This rear release mechanism allows for the handle to be removed so that the lid of a cooking grill can be closed without the handle being in the way. Removing the handle also keeps it from getting hot when the food is being grilled in the grilling basket.

### CROSS REFERENCE TO RELATED APPLICATION(S)

This application claims priority to provisional Patent Application No. 63/739,462 filed on Dec. 27, 2024, having a title “Grilling Basket with Quick Remote Release Handle”, the contents of which are incorporated by reference herein.

### FIELD OF THE INVENTION

The present invention relates to a grilling basket having a rear release handle.

### BACKGROUND

The background description includes information that may be useful in understanding the present invention. It is not an admission that any of the information provided herein is prior art or relevant to the invention, or that any publication specifically or implicitly referenced is prior art.

A grilling basket is a mesh container commonly used for grilling small or delicate food items that may fall through the grates of a grill otherwise. Grilling baskets enable the food to cook evenly while being exposed to heat and smoke, thus offering a convenient mechanism to grill food. Typically, conventional grilling baskets are placed on a grill directly or by using an attached handle. The handle facilitates carrying the basket, placement of the basket on a grill, and manipulation of food inside the basket. However, since grills are set for high temperatures, the user would need heat protective gear, such as gloves or other tools, to place the basket directly on the grill. Grilling baskets which utilize a large handle typically interfere with the lid of the grill by either requiring the grill lid to stay in an open position or resting the grill lid on the handle. Since these grilling baskets do not allow for a sealed grill, the internal temperature of the grill will not be regulated for proper grilling. Some conventional grilling baskets have a removable handle to avoid this problem. However, the handle cannot be easily removed or reconnected from the basket when it is placed on a hot grill. Even though these grilling baskets have a removable handle, the mechanism allowing for the separation and reconnection of the basket from the handle is adjacent to the basket. Thus, a user must detach the grilling basket from the handle near the hot grill. As such, the user would again require heat protective gear to engage and disengage the grilling basket from the handle.

### SUMMARY

Accordingly, there is a need for a grilling basket having a handle that is configured to be released away from the heat zone of a cooking grill (or “grill”).

In accordance with one or more embodiments, the invention relates to a novel grilling apparatus for engaging and disengaging a grilling basket from a handle quickly and away from the grill heat. The grilling apparatus includes a grilling basket and a releasable handle. The handle includes a release mechanism that is configured to be actuated at a rear end of the handle. This rear release mechanism allows for the handle to be removed so that the lid of the grill can be closed without the handle being in the way. Removing the handle also keeps it from getting hot when the food is being grilled in the grilling basket.

In an embodiment, the handle can be connected to the grilling basket symmetrically. This allows the grilling basket to be turned over and connected to, or disconnected from, the handle without the use of protective gloves or other heat protection gear. The handle can be configured to slide easily on and off the grilling basket. The handle can have a length that facilitates storage in the basket.

Various objects, features, aspects, and advantages of the inventive subject matter will become more apparent from the following detailed description of preferred embodiments and the accompanying drawing figures in which like numerals represent like components.

### BRIEF DESCRIPTION OF DRAWINGS

The invention will be described in further detail below and with reference to the attached drawings, all of which describe or relate to apparatus, systems and methods of the present invention. In the figures, which are not intended to be drawn to scale, each similar component that is illustrated in various figures is represented by a like numeral. In the figures:

FIG. 1 depicts a grilling apparatus having a grilling basket and connected handle, according to an embodiment.

FIG. 2 depicts the handle disconnected from the grilling basket, according to an embodiment.

FIG. 3 depicts the handle disconnected from the grilling basket with an open catching mechanism, according to an embodiment.

FIGS. 4A-4C depict multiple views of the grilling basket, according to an embodiment.

### DETAILED DESCRIPTION OF THE INVENTION

Depending on the context, all references below to the “invention” may in some cases refer to certain specific embodiments only. Various terms are used herein. To the extent a term used herein is not defined below, it should be given the broadest definition persons in the pertinent art have given that term as reflected in printed publications and issued patents at the time of filing.

A grilling apparatus having a grilling basket (the term “basket” and “grilling basket” are used interchangeably hereinafter) and a releasable handle is disclosed herein. The handle is configured to be released or disconnected from the basket away or remotely from the grill.

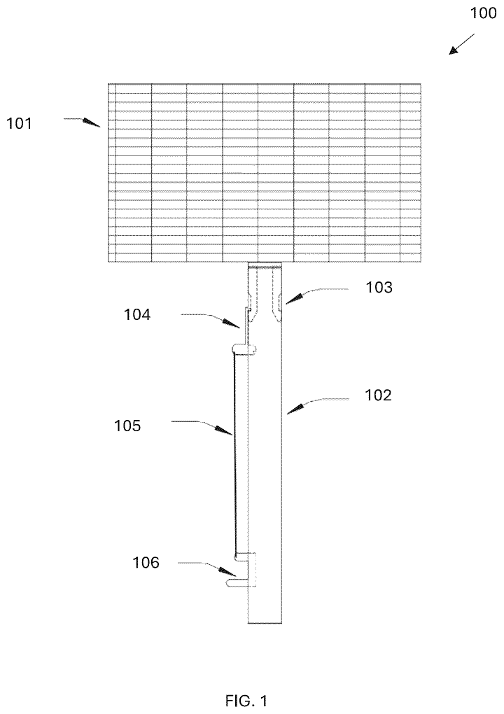

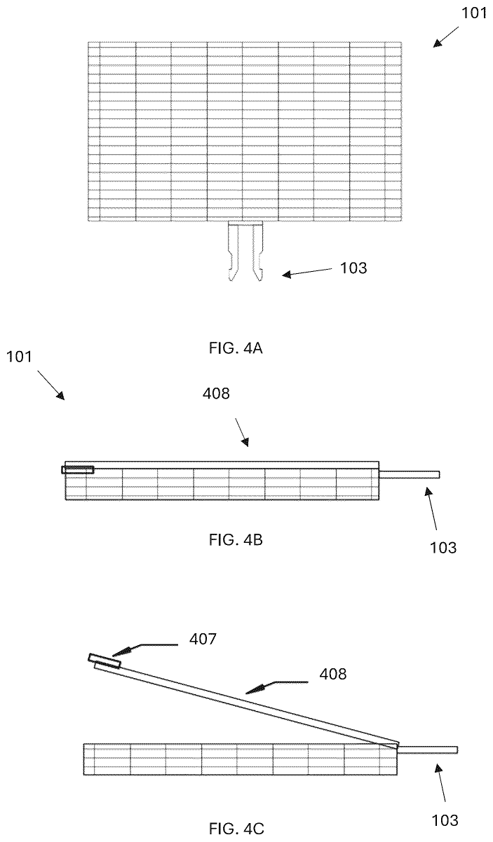

Now referring to FIG. 1, the grilling apparatus 100 includes a basket 101 and a handle 102. The basket 101 can include a hook 103 and a lid and closure (which will be discussed in more detail in reference to FIG. 4). The hook 103 can be located along a side of the basket. For instance, the hook 103 can be located along a posterior end of the basket 102. The hook 103 can be configured for easy insertion to the handle 102. The handle 102 includes a release mechanism for disconnecting the hook 103 from the handle. The release mechanism comprises a catching mechanism 104, a tie rod 105, and a pullback mechanism 106. The tie rod 105 extends axially along the handle 102 and connects the catching mechanism 104 and the pullback mechanism 106. The catching mechanism 104 is located at the front end/anterior portion of the handle and is configured to engage with and disengage from the hook 103. The pullback mechanism 106 is located at a rear end/posterior portion of the handle; further, the pullback mechanism 106 is located posterior to the catching mechanism 104. As shown, the catching mechanism 104 is configured to firmly and securely engage with the hook 103 and avoid it from being disengaged from the basket 101 until the catching mechanism 104 is released or opened by pulling back the pullback mechanism 106. This allows the basket 101 to be firmly attached to the handle 102 for basket movement and rotation on the grill. In another embodiment (not shown), the handle 102 can be configured to be directly connected to the basket 101 without any hook, which can allow for a smaller basket without a protruding hook.

The handle 102 is configured for dis-connection and reconnection to the basket 101 with as little force as possible to reduce movement of the basket especially when it is placed on the grill. The handle 102 can easily slide onto the hook 103 thereby engaging the catching mechanism 104 with the hook 103. The handle 102 can be inserted symmetrically so the basket 101 can be reversed, if required, thereby allowing for easy turning/movement of the basket. In an embodiment, the front portions of the hook 103 and the catching mechanism 104 are tapered. This allows the handle 102 to be slidably connected to the basket 101 such that the hook 103 is engaged with the catching mechanism 104, without having to depress the pullback mechanism 106. In one or more embodiments, the hook 103 is securely held within the handle 102.

The hook 103 and the catching mechanism 104 are manufactured from suitable materials, and fit/engage such that the handle 102 can be readily connected to the basket 101 without having to put excessive force that would move the basket as little as possible.

As used herein, the term “hook” includes any mechanism for receiving the catching or locking mechanism. For example, in one or more embodiments, the hook can include one or more tapered or indented legs. As used herein, the term “catching mechanism” can include any structural mechanism for securing the handle to the hook. For example, in or more embodiments, the catching mechanism can include, but is not limited to, flat hooks, pins, a sleeve, and other such mechanisms that can securely engage with the hook. The catching mechanism can also be conveniently tapered to engage with the hook. As used herein, the term “rod” includes a connector mechanism, such as, but not limited to, a wire, bar or rod, that is configured to connect the catching mechanism and the pull. Additionally, the term “pullback mechanism” can include any structural mechanism that when depressed or pulled back, ensures that the catching mechanism is released from the hook. For example, the pullback mechanism can include, but is not limited to, a push button, a trigger, a lever, or another mechanism that can release or disengage the catching mechanism from the hook.

As shown, the basket 101 can have a rectangular shape, and the handle 102 can be tubular/cylindrical in shape. However, it is understood that the basket 101, handle 102 and hook 103 can have any other suitable structure or shape. For instance, the basket 101 can be round, square, flat or any other suitable shape or size. Similarly, the shape and size of the handle 102 can be varied without impacting the functionality of the grilling apparatus 100. Additionally, the hook 103 can also have a variety of shapes. In one or more embodiments, the shape of the hook 103 is reversible and is designed to support the basket 101 firmly to the handle 102.

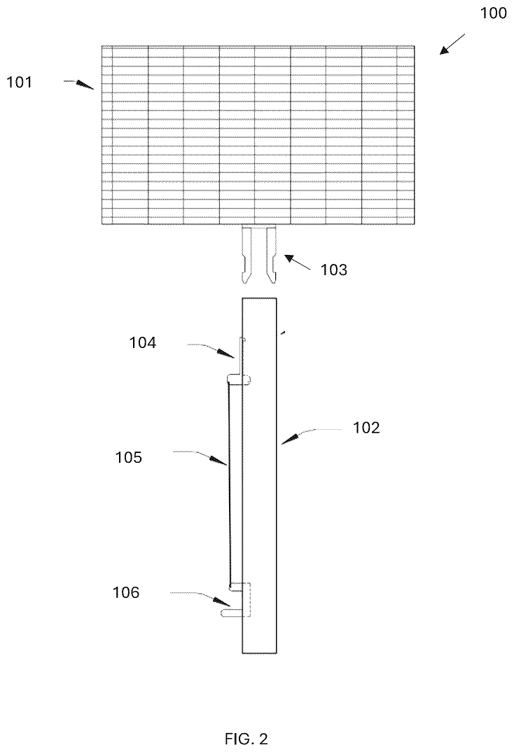

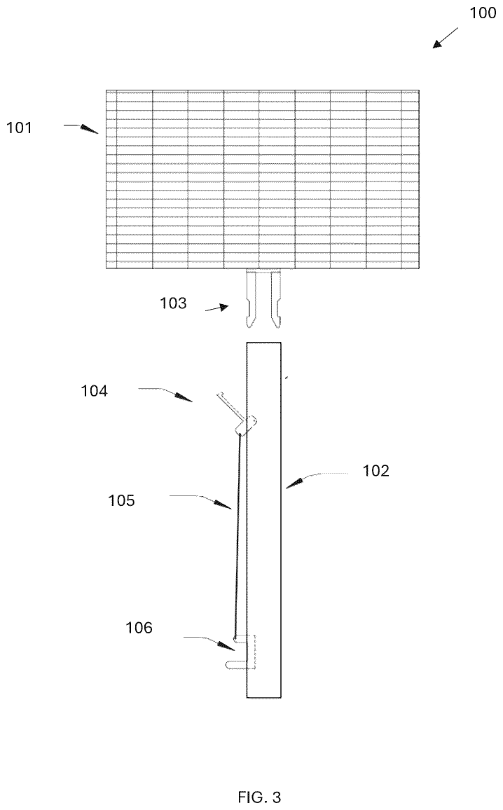

As shown in FIG. 2, the handle 102 is disconnected from the basket 101 and aligned for insertion to the basket hook 103. FIG. 3 illustrates the handle 102 disconnected from the basket 101 with the catching mechanism 104 in an open position. When the catching mechanism 104 is opened, the basket 101 can be removed from the handle 102. The catching mechanism 104 is fully activated by depressing or pulling back the pullback mechanism 106. Accordingly, as a user triggers the pullback mechanism 106, the tie rod 105 causes a disengagement of the catching mechanism 104 from the hook 103. Advantageously, the pullback mechanism 106 is located on the handle such that it is not exposed to the high temperatures of the grill.

In one embodiment, a method of operating the grilling apparatus comprises depressing the pullback mechanism 106 such that the pressure on the tie rod 105 is released and it releases the catching mechanism 104 from the hook 103. The rear quick release mechanism allows for the handle to be removed, as needed, so the grill lid can be closed without the handle being in the way. Additionally, removing the handle 102 ensures it does not get hot from staying in the grilling area during the cooking time. The handle can be removed from or attached to the basket while the basket is on the grill. Since the engagement and disengagement of the basket 101 from the handle 102 can be triggered by the pullback mechanism 106 from the rear portion or posterior portion of the handle, the grilling apparatus 100 can be used without additional heat protection gear.

In an embodiment, the handle 102 has a length that is suitable for convenient storage in the basket 101.

FIGS. 4A-4C depict multiple views of basket 101. As shown, the basket 101 includes a lid 408, a hook 103 and lid hatch or closure 407. The lid 408 and closure 407 ensure the food items are securely held in place during the grilling process. The lid 408 and closure 407 further allow the basket 101 to be flipped during use without the risk of spilling the food.

The basket and handle can be made of a suitable material, such as metals, or high-temperature polymers, that can withstand high grill temperatures.

The connection and latching between the handle and the basket only needs to be achieved in a secure manner, such that the basket can be placed and turned on the grill, and the handle can be removed from the grill without the need for protective gear from the high grill temperatures.

Additionally, in one or more embodiments, the components of the release mechanism, namely, the catching mechanism 104, rod 105 and pullback mechanism 106 can be internal and/or external to the handle. The pullback mechanism 106 can be located anywhere on the handle that can be accessed clear of the grilling area and high cooking temperatures. The catching mechanism is configured such that it can automatically engage with the hook. However, in one or more embodiments, the catching mechanism can be manually attached to the hook. The connection components of the handle to the basket should be of materials and fit such that the handle can be readily connected to the basket without having to put excessive force and would move the basket as little as possible.

There are many conventional grilling baskets with removable handles but none of them have handles that can be easily removed or reconnected on or near a hot grill. In the one or more embodiments of the present invention, the handle can be quickly and easily removed, or reconnected, to the grilling basket outside of the grill heat. Conveniently, the basket can be easily inserted into and removed from the handle using a hook and catching mechanism. The catching mechanism can be opened remotely from the rear of the handle out of the heat of the grill. The hook can be inserted into the handle so that the basket can be connected to the handle symmetrically such that the basket can be turned over and connected from either side. The disconnect or pullback mechanism is located towards the rear of the handle, out of the heat of the grill, so the disconnection of the handle from the basket can be done without any special heat-resistant protection. Connecting or disconnecting the basket from the handle out of the grill heat makes the handle easily removable from the basket while the grill and grilling basket are hot.

The one or more embodiments of the invention can be applied in any industry where a handle needs to be removed from a high temperature tool, such as, but not limited to, glass blowing, or crucible handling. Additionally, the embodiments of the invention can be used by anybody that uses a grilling basket, in a grill, oven or stove, where the handle would be in the way or obstruct in the opening or closing of a door or cover.

Therefore, the present invention is well adapted to attain the ends and advantages mentioned as well as those that are inherent therein. The previous description is not intended to limit the invention, which may be used according to different aspects or embodiments without departing from the scope thereof. The discussion of acts, materials, devices, articles and the like is included in this specification solely for the purpose of providing a context for the present invention. It is not suggested or represented that any or all of these matters formed part of the prior art base or were common general knowledge in the field relevant to the present invention.

Furthermore, the particular illustrative embodiments disclosed above may be altered or modified and all such variations are considered within the scope and spirit of the present invention. While systems and methods are described in terms of “comprising,” “containing,” or “including” various devices/components or steps, it is understood that the systems and methods also can “consist essentially of” or “consist of” the various components and steps. Whenever a numerical range with a lower limit and an upper limit is disclosed, any number and any included range falling within the range is specifically disclosed. In particular, every range of values (of the form, “from about a to about b,” or, equivalently, “from approximately a to b”) disclosed herein is to be understood to set forth every number and range encompassed within the broader range of values. If there is any conflict in the usages of a word or term in this specification and one or more patent(s) or other documents that may be incorporated herein by reference, the definitions that are consistent with this specification should be adopted.

1. A grilling apparatus, comprising:
(i) a grilling basket, wherein the basket comprises a hook;
(ii) a handle, wherein the handle further comprises a release mechanism,
wherein the release mechanism comprises a catching mechanism to facilitate engagement with/disengagement of the hook and the handle,
wherein the release mechanism further comprises a pullback mechanism located at a rear end of the handle, and
wherein the pullback mechanism is located distal to the catching mechanism.

2. The grilling apparatus according to claim 1, wherein the basket further comprises a lid and a closure.

3. The grilling apparatus according to claim 1, wherein the release mechanism further comprises a tie rod, the tie rod connecting the catching mechanism and the pullback mechanism.

4. The grilling apparatus according to claim 1, wherein the hook and the catching mechanism have a tapered front portion to facilitate slidable coupling of the basket and the handle.

5. The grilling apparatus according to claim 1, wherein the pullback mechanism is configured to disconnect the catch mechanism from the hook.

6. The grilling apparatus according to claim 1, wherein the handle is sized for storage in the basket.

7. The grilling apparatus according to claim 1, wherein the handle is configured for symmetrical coupling with the basket such that the basket can be reversed and rotated.
